(19) United States
(12) Patent Application Publication
(10) Pub. No.: US 2012/0094138 A1
(43) Pub. Date: Apr. 19, 2012

(54) Fire Resistant Paint and Article

(75) Inventors: Michael A. Bilodeau, Brewer, ME (US); Mark A. Paradis, Old Town, ME (US)

(73) Assignee: UNIVERSITY OF MAINE SYSTEM BOARD OF TRUSTEES, Bangor, ME (US)

(21) Appl. No.: 13/061,583

(22) PCT Filed: Sep. 18, 2009
(86) PCT No.: PCT/US2009/057423

§ 371 Date: Jun. 20, 2011

Related U.S. Application Data
(60) Provisional application No. 61/098,268, filed on Sep. 19, 2008.

(51) Int. Cl. B32B 21/04; B32B 29/00; C08K 3/22

(52) U.S. Cl. 428/532; 524/430

(57) ABSTRACT

A fire resistant paint includes a film-forming binder, a solvent, and a hydrated mineral that imparts fire resistance to the paint. The paint, when applied to a fibrous composite article which comprises at least about 20 wt % lignocellulosic fibers bound together into a consolidated fibrous article, provides the article with a flame spread index of not greater than about 50.

### BACKGROUND OF THE INVENTION

This invention relates in general to fire resistant coatings, and more particularly to a fire resistant paint which can be used to improve the fire resistance of articles coated with the paint.

In many applications it is desirable to provide fire resistant articles. For example, the flammability characteristics of building materials play a major role in losses caused by fires. The occurrence of large fires in buildings is often distinguished by a rapid flame spread on the building materials. As a result, the flame spread and other burning characteristics of building materials are now regulated to reduce these losses.

Various fire resistant coatings are known for use on building materials and other articles. However, there still exists a need for an improved fire resistant paint.

### BRIEF DESCRIPTION OF THE DRAWING

FIG. 1 is a perspective view of a ceiling tile coated with a fire resistant paint according to the invention.

### DETAILED DESCRIPTION OF THE PREFERRED EMBODIMENTS

The present invention relates to a fire resistant paint composition. The term “paint” includes any type of coating that can be applied to an article, such as paints, primers, varnishes, stains, lacquers, glazes and the like. The paint comprises a film-forming binder, a solvent and a hydrated mineral.

Any type of film-forming binder, or any combination of different binders, suitable for use in coatings can be used in the paint. In addition to forming a film on a surface of the coated article, the binder also imparts adhesion and binds together the other paint components. Generally, there are two classes of binders: latex and alkyd-based binders which result in what are known as latex paints and alkyd paints. Some binders are synthetic resins or natural resins. Examples of synthetic resins that may be suitable include acrylic resins, vinyl resins, polyester resins, alkyd resins, butadiene resins, styrene resins, phthalic acid resins, urethane resins, epoxy resins, and the like. Some particular examples of latex-based binders include poly(vinyl acetates), acrylics, vinyl acrylics, vinyl acetate copolymers, polymerized acrylates, such as polymerized butylacrylate, and the like. In a particular embodiment the binder is a PB 6820 styrene-acrylic latex polymer manufactured by Dow Chemical Co., Midland, Mich. Some paints include a water-soluble polymer such as poly(vinyl alcohol) as a binder. Any suitable amount of film-forming binder can be used in the paint, for example, an amount within a range of from about 25% to about 75% by weight of the paint.

Any type of solvent, or any combination of different solvents, suitable for use in coatings can be used in the paint. When the paint is applied to an article, the solvent evaporates leaving behind the other paint components on the surface of the article. The solvent acts as the carrier for the other components and adjusts the viscosity of the paint. If a latex-based binder is used, the solvent is usually aqueous and if an alkyd-type binder is used, the solvent is usually non-aqueous. Examples of aqueous-based solvents include water, and water-based solutions such as water-alcohol mixtures and the like. Examples of non-aqueous solvents include organic-based solvents such as toluene, ketones such as methylethyl ketone or methylisobutyl ketone, benzene, ethyl acetate, white spirit, alkanes, cycloalkanes, other aromatic compounds, and isoparaffinic solvents. In a particular embodiment the solvent is water. Any suitable amount of solvent can be used in the paint, for example, an amount within a range of from about 25% to about 75% by weight of the paint.

The paint usually includes a pigment, although in some embodiments it may not be required. Any type of pigment, or any combination of different pigments, suitable for use in coatings can be used. The pigment can be any type of coloring and/or opacifying material. Some examples of pigments that may be suitable include titanium dioxide, zinc oxide, titanium calcium, phthalo blue, and red iron oxide. In a particular embodiment the pigment is titanium dioxide. Any suitable amount of pigment can be used in the paint, for example, an amount within a range of from about 5% to about 25% by weight of the paint.

The hydrated mineral included in the paint imparts fire resistance to the paint. Although the invention is not limited by theory, it is believed that the hydrated mineral provides an endothermic water release under heating and burning conditions that effects a fire retardant action. Any type of hydrated mineral, or combinations of different hydrated minerals, suitable for imparting fire resistance to coatings can be used. Some examples of hydrated minerals that may be suitable include aluminum trihydrate, magnesium hydroxide, magnesium bromate hexahydrate, magnesium sulfate heptahydrate, magnesium iodate tetrahydrate, magnesium antimonate hydrate, magnesium chlorplatinate hexahydrate, calcium ditartrate tetrahydrate, calcium chromate dihydrate, sodium thiosulfate pentahydrate, sodium pyrophosphate hydrate, potassium ruthenate hydrate, potassium sodium tartrate tetrahydrate, zinc iodate dihydrate, zinc sulfate heptahydrate, zinc phenol sulfonate octahydrate, manganese chloride tetrahydrate, cobalt orthophosphate octahydrate, beryllium oxalate trihydrate, zirconium chloride octahydrate, thorium hypo phosphate hydrate, thallium sulfate heptahydrate, and dysprosium sulfate octahydrate. In a particular embodiment, the hydrated mineral is aluminum trihydrate (“ATH”, also known as “alumina trihydrate”). The hydrated mineral is included in any suitable amount, for example, an amount within a range of from about 5% to about 50% by weight of the paint.

Besides the above-mentioned components, the paint can optionally also include one or more other components suitable for use in coatings. For instance, such components may include thickeners, extenders, dispersants, lubricants, wetting agents, suspension aids, thixotropic agents, crosslinkers, water repellants, and the like.

Any suitable thickeners(s) can be used in the paint. In a particular embodiment, the paint includes an organic thickener such as a cellulose derivative or a polysaccharide. Some examples of cellulose derivatives include carboxymethyl-cellulose and hydroxyalkylcellulose such as hydroxymethyl-, hydroxyethyl- or hydroxypropylcellulose.

Any suitable extender(s) can be used in the paint. Some particular examples of extenders are oxy compounds of calcium, magnesium, aluminum, and silicon such as clays (for example, kaolin or bentonite), chalk, limestone, and talc.

Any suitable dispersant(s) can be used in the paint. In a particular embodiment, the paint includes an organic dispersant such as DISPEX N-40 which is a 40% solids dispersion of sodium polycarboxylate manufactured by Allied Colloids.

The paint can be produced in any suitable manner, for example by combining the components in a mixer, disperser, mill or other suitable apparatus. The components can be combined in any suitable order.

The paint can be applied to a surface of an article in any suitable manner such as by brush, air-spraying, or other means of applying coatings. The paint can be applied in any thickness suitable for providing the desired fire resistance and other properties to the article. In a particular embodiment, the paint is applied to the article in a thickness within a range of from about 10 microns to about 500 microns. When the surface of the article is porous the paint may soak into the surface.

The paint can be applied to substantially any type of article made from substantially any type of material. For example, the paint can be applied to a building material made from wood, brick, glass, plaster, cinder blocks, stone, metal, drywall, and other materials.

In a particular embodiment, the paint is used to coat a fibrous composite article. The composite article includes fibers bound together into a consolidated fibrous article. The term “fiber” as used herein includes any fibrous and/or particulate material. Any type of fiber, or a combination of different fibers, suitable for producing composite articles can be used. Some nonlimiting examples of fibers that may be suitable include lignocellulosic fibers, polymer fibers, carbon fibers, or any type of inorganic fibers such as mineral fibers or metal oxide fibers. Some nonlimiting examples of lignocellulosic fibers are those produced from wood, sugar cane residue (bagasse), hemp stalks, straw, cornstalks and sunflower stalks. Some nonlimiting examples of mineral fibers include fibers of a heat-softenable mineral material, such as glass, wollastonite, ceramic, rock, slag, or basalt. Mineral wool consists of fibers made from minerals or metal oxides. The fibers can have any suitable particle sizes.

In a particular embodiment the fibers used in the composite article are substantially all lignocellulosic fibers. In another embodiment, the composite article includes a mixture of lignocellulosic fibers and inorganic fibers. Some nonlimiting examples of such composite articles include lignocellulosic fibers in an amount within a range of from about 50 wt % to about 90 wt % (by dry weight of the consolidated fibrous article), more particularly from about 60 wt % to about 80 wt %, and inorganic fibers in an amount within a range of from about 10 wt % to about 50 wt %, more particularly from about 20 wt % to about 40 wt %. In a particular embodiment the inorganic fibers comprise mineral wool.

The fibers can be included in any suitable amount in the composite article. In some embodiments, the fibers are included in an amount within a range of from about 40% to about 85% by dry weight of the consolidated fibrous article, particularly from about 45% to about 75%, and more particularly from about 55% to about 70%.

The fibers of the composite article may be bound together without the use of a binder. As a nonlimiting example, lignocellulosic fibers may naturally develop hydrogen bonding when they are formed into a composite article under pressure and high temperature. Alternatively, the composite article may further include a binder. Any type of binder, or any combination of different binders, suitable for making a composite article can be used. Some nonlimiting examples of binders are starch binders such as corn starch, wheat starch and potato starch; and synthetic resins such as urea formaldehyde, melamine formaldehyde, phenol formaldehyde, methylene diphenyl diisocyanate, and polyurethane resin.

In addition to the above-described materials, the composite article may optionally include other materials suitable for making such articles. By way of nonlimiting example, the composite article may include a water repelling agent to improve the moisture resistance of the article. Any type of water repelling agent, or any combination of different water repelling agents, suitable for making composite articles can be used. Some nonlimiting examples of water repelling agents include waxes, oils, and hydrophobic chemicals such as alkylalkoxysilanes. By way of nonlimiting example, any suitable synthetic or natural wax or combinations thereof can be used.

The composite article may also include one or more fillers. Any type of filler, or any combination of different fillers, suitable for making composite articles can be used. Some nonlimiting examples of fillers that may be suitable are inorganic fillers such as various clays (including but not limited to bentonite and kaolin), both expanded and unexpanded versions of pearlite and/or vermiculite, calcium carbonate, zeolite, silica, talc, mica, gypsum and fly ash.

In some embodiments, the use of the fire resistant paint allows the production of a fibrous composite article which includes a higher amount of lignocellulosic fibers and a relatively low amount of inorganic fillers while still achieving good flame resistant properties. For example, the fibrous composite article may include at least about 20 wt % lignocellulosic fibers, more particularly at least about 30 wt %, and less than about 30 wt % inorganic filler, more particularly less than about 20 wt %.

Any other additives suitable for use in composite articles can optionally be included. Some nonlimiting examples of additives include retention aids, dry strength additives, biological control agents and processing aids. Any suitable retention aid or mixtures of different retention aids can be used, which can include by way of nonlimiting example many different types of cationic, anionic, nonionic or zwitterionic materials. Any suitable processing aids or mixtures of different processing aids can be used, which can include without limitation aluminum sulfate or sodium aluminate.

In some embodiments, the composite article further comprises a water repelling agent present in a suitable range. As a nonlimiting example, such a water repelling agent may be present within a range of from about 0.1% to about 10% by dry weight of the consolidated fibrous article, particularly from about 0.25% to about 4%, and more particularly from about 0.5% to about 3%. Any suitable water repelling agent can be used.

The structures and methods of manufacturing composite articles are well-known in the building materials field, so they will be described only briefly below.

Hardboards are panels manufactured primarily from interfelted lignocellulosic fibers which are consolidated under heat and pressure in a hot press. They typically have a density above 500 kg/m³, and more typically in the range of 800-1100 kg/m³. Other materials may be added to improve certain properties such as stiffness, hardness, finishing properties, resistance to abrasion and moisture as well as to increase strength, durability and utility. Hardboards may be produced by many processes, including the well-known wet process or dry process.

Insulating fiberboards, also known as softboards and low density fiberboards, are fibrous felted homogenous panels made from lignocellulosic fibers. They typically have a density in the range of 160-500 kg/m³. These boards are characterized by an integral bond which is produced by interfelting of the fibers, but which are uncompressed or lightly compressed. Other materials may be added during manufacture to improve certain properties.

Particle boards are made from fibers such as wood chips, sawmill shavings or sawdust, and other materials. The components are mixed together and formed into a sheet, which is then compressed under pressure and high temperature. The particle boards typically have a density from 590-800 kg/m³.

Oriented strand boards are made from fibrous strands and other materials. The strands are layered in specific orientations and the components are formed into a sheet, which is then compressed under pressure and high temperature.

Wood-plastic composites are made from thermoplastic polymers, fibers such as wood dust (wood flour) or wood fibers, and other materials. The fibers and other materials are combined with molten thermoplastic polymer to produce a homogeneous mixture, which is then formed into the shape of the composite article by extrusion or molding.

The painted article of the invention can be used in a wide variety of different applications. In some embodiments, the article is used as part of a roofing system, as exterior sheathing, or as part of an interior application, in residential, commercial, industrial or institutional construction. By way of nonlimiting example, the article may be used in a roofing system as cover board, recover board, insulation board, cant strip, or tapered edge segment. The article may be used as structural or non-structural exterior sheathing. The article may be used in an interior application including without limitation a floor, wall or ceiling or any application within the interior of a building, including without limitation part of a sound control panel, a core material for a door, a partition, furniture, a tack board, a dry erase board or other display material, or a ceiling panel.

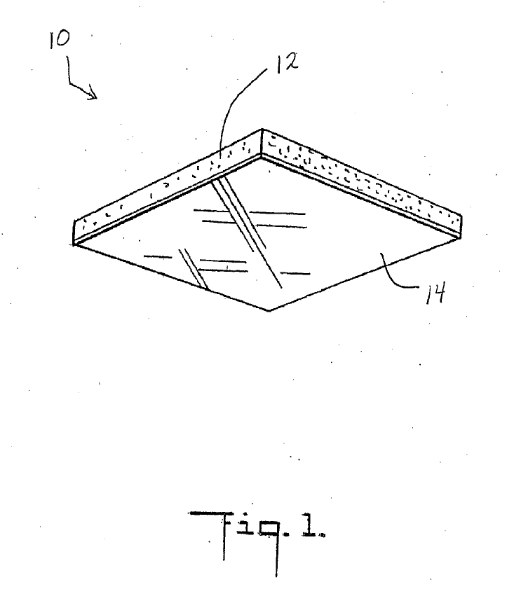

In one embodiment, the painted article is used as a ceiling tile or panel in a dropped ceiling. Dropped or suspended ceilings consist of a grid of metal channels in the shape of an upside-down “T” suspended on wires from the overhead structure. The channels leave openings in the grid, typically 2×2 feet or 2×4 feet, into which the ceiling tiles are fitted. The ceiling tiles are rigid and self-supporting so they do not sag and/or break. The ceiling tiles can have any suitable thickness, typically between ½ inch and 1 inch. They can be painted on just the exterior surface or also on other surfaces. FIG. 1 shows an example of a ceiling tile 10 including a fiberboard 12 coated with a fire resistant paint 14 according to the invention.

The fire resistant paint improves the fire resistance of the article coated with the paint. The improved fire resistance can be measured in any suitable manner, for example by a Flame Spread Index (FSI) described below. In a particular embodiment, an article formed from a structural lignocellulosic composite which is coated with the paint has a flame spread index of not greater than about 100, particularly not greater than about 75, and more particularly not greater than about 50. In some embodiments a painted article has a class A fire resistance rating under the applicable building standard, meaning that it is not readily flammable, it is effective against severe fire exposures, and it does not carry or communicate (spread) fire.

### EXAMPLES

### Example 1

A fire resistant paint (“ATH Paint”) according to the invention was tested for flame spread resistance versus a standard paint. The compositions of the paints are shown below:

| ATH Paint: | Standard Paint: |
|---|---|
| 2.375 g CMC into 125 g water | 0.59 g CMC into 125 g water |
| add 125 g dry ATH | add 125 g KCS clay |
| add 225 g 50% TiO2 slurry | add 225 g 50% TiO2 slurry |
| add 25 g latex PB6820 | add 25 g water |
| add 2 drops dispersant N-40 | add 125 g PVOH 10% cooked |
| | add 2 drops dispersant N-40 |

The paints were applied by spraying to completely cover the surfaces of wood fiberboard samples measuring 18 in. (460 mm) wide by 24 ft. (7.3 m) long by ½ in. (12.7 mm) thick. The fiberboards were industrial insulation board available from Knight-Celotex in Lisbon Falls, Me. The fiberboard samples had wood fiber contents varying between 15% and 30%.

The painted fiberboard samples were tested for Flame Spread Index using a method similar to that described in Underwriters Laboratories Standard UL 723, “Test for Surface Burning Characteristics of Building Materials”, as well as ASTM E-842. The test measures time and distance at which a flame propagates horizontally along the surface of the sample. The test is conducted with the sample mounted in the “ceiling” position of an enclosed tunnel furnace measuring 18 in. (460 mm) wide by 12 in. (300 mm) deep by 25 ft. long (7.6 m). A nominal 5000 Btu/min. (88 kW), 4½ ft. (1.4 m) flame provides an ignition source to the underside of the mounted sample for a 10-minute duration. A controlled inlet draft of 240 feet per minute (1.2 meters/second) facilitates horizontal flame propagation throughout the test. Flame spread is reported in comparison with calibration materials of red oak lumber and inorganic reinforced cement board. Red oak propagates flames to the end of the tunnel in 5 minutes 30 seconds and generates a flame spread index of approximately 90, while inorganic reinforced cement board generates a flame spread index of zero. The flame spread index is calculated according to the following: A. Flame spread index=0.515Aₜ when Aₜ is ≦97.5 min-ft. B. Flame spread index=4900÷195−Aₜ when Aₜ is >97.5 min-ft. Where Aₜ=the total area under the time distance curve expressed in min-ft.

The following results were obtained from the flame spread testing:

Flame Spread Index

| fiber content | ATH Paint | Standard Paint |
|---|---|---|
| 15% | 19 | 21 |
| 20% | 28 | 48 |
| 30% | 42 | 64 |

Note:
Lower FSI = better flame spread resistance

The results show that the ATH paint according to the invention resulted in significantly better flame spread resistance of painted fiberboards compared to the same fiberboards painted with a standard paint. The improvement in flame spread resistance is particularly great with the fiberboards having 20% and 30% wood fiber content.

### Example 2

Another embodiment of a fire resistant paint according to the invention is made with the following composition:

130 g water

125 g dry magnesium hydroxide

2 g hydroxyethylcellulose
100 g phthalo blue
25 g vinyl acetate copolymer latex
2 drops dispersant
30 g bentonite clay

### Example 3

Another embodiment of a fire resistant paint according to the invention is made with the following composition:

150 g toluene

2.3 g hydroxypropylcellulose

125 g dry calcium chromate dihydrate

225 g 50% TiO2 slurry

25 g alkyd resin binder

### Example 4

A fibrous composite is formed from the following materials: 70% wood fibers, 10% vermiculite filler, 18% starch binder, and 2% water repellent. The composite is formed into an industrial insulation board and then cut into the shape of a ceiling tile as shown in FIG. 1. The ceiling tile is spray painted on its bottom side with a fire resistant paint made as described in Example 1. The ceiling tile has a flame spread index of 45.

1. A fire resistant paint comprising a film-forming binder, a solvent, and a hydrated mineral that imparts fire resistance to the paint;
the paint, when applied to a fibrous composite article which comprises at least about 20 wt % lignocellulosic fibers bound together into a consolidated fibrous article, providing the article with a flame spread index of not greater than about 50.

2. The paint of claim 1 wherein the hydrated mineral is included in an amount within a range of from about 5% to about 50% by weight of the paint.

3. The paint of claim 2 wherein the hydrated mineral comprises aluminum trihydrate.

4. The paint of claim 3 wherein the film-forming binder comprises a latex-based binder.

5. The paint of claim 4 wherein the solvent comprises water.

6. The paint of claim 5 which further comprises a dispersant.

7. The paint of claim 1 wherein the film-forming binder comprises an alkyd-based binder.

8. The paint of claim 7 wherein the solvent comprises an organic solvent.

9. A fire resistant article comprising:
an article formed from a fibrous composite which comprises at least about 20 wt % lignocellulosic fibers bound together into a consolidated fibrous article; and
a fire resistant paint coating the article, the paint comprising a film-forming binder, a solvent, and a fire retarding hydrated mineral;
the painted article having a flame spread index of not greater than about 50.

10. The fire resistant article of claim 9 wherein the composite comprises at least about 30 wt % lignocellulosic fibers.

11. The fire resistant article of claim 10 wherein the composite comprises less than about 30 wt % inorganic filler.

12. The fire resistant article of claim 11 wherein the composite comprises less than about 20 wt % inorganic filler.

13. The fire resistant article of claim 12 wherein the article comprises a fiberboard panel.

14. The fire resistant article of claim 13 wherein the article comprises a ceiling tile.

15. The fire resistant article of claim 14 wherein the painted article has a flame spread index of not greater than about 45.

16. The fire resistant article of claim 15 wherein the painted article has a flame spread index of not greater than about 40.

17. The paint of claim 16 wherein the hydrated mineral is included in an amount within a range of from about 5% to about 50% by weight of the paint.

18. The fire resistant article of claim 17 wherein the hydrated mineral comprises aluminum trihydrate.

19. A fire resistant article comprising:
an article formed from a fibrous composite which comprises at least about 20 wt % lignocellulosic fibers bound together into a consolidated fibrous article; and
a fire resistant paint coating the article, the paint comprising a film-forming binder, a solvent, and a fire retarding hydrated mineral;
the painted article having a flame spread index at least about 5 points better than the same article coated with the same paint without the hydrated mineral.

20. The fire resistant article of claim 19 wherein the flame spread index is at least about 10 points better.
